(19) United States
(12) Patent Application Publication
(10) Pub. No.: US 2024/0140178 A1
(43) Pub. Date: May 2, 2024

(54) Built-in roll cover

(71) Applicant: ZHEJIANG SURPASS AUTO PARTS CO.,LTD., Wenzhou City (CN)

(72) Inventors: Yi Lin, Wenzhou City (CN); Lei Lin, Wenzhou City (CN)

(21) Appl. No.: 18/190,188

(22) Filed: Mar. 27, 2023

(30) Foreign Application Priority Data
Oct. 28, 2022 (CN) 202211332674.2

(51) Int. Cl. B60J 7/10; B60J 7/08

(52) U.S. Cl. CPC B60J 7/102; B60J 7/085

(57) ABSTRACT

The invention discloses a built-in roll cover, includes a layer of leather and a support frame, the layer of leather is connected with the support frame, the support frame includes a large front bar assembly, a side rail assembly and a rear bar assembly, the large front bar assembly is connected to the rear bar assembly through a side rail assembly, the side rail assembly is connected to the side rail of the car through a clamp assembly, the large front bar assembly includes a large front bar and a large front bar plug strip, the large front bar is provided with a large front bar groove, the large front bar plug strip is connected with the layer of leather, the large front bar plug strip is stuck in the large front bar groove, the rear bar assembly is connected to the side rail assembly through the rear bar fixing assembly, the rear bar fixing assembly includes a rear bar joint and a rear bar fixing base, the rear bar fixing base is connected with the side rail assembly, the rear bar joint is engaged with the rear bar assembly. By providing a large front bar plug strip, the present invention allows the layer of leather cling to the support frame, which makes the overall waterproof effect of the roll cover better.

### TECHNICAL FIELD

This invention is relevant to automobile accessories, especially a built-in roll cover for a pickup truck.

### BACKGROUND TECHNOLOGY

The cargo hopper of a pickup truck (also known as a sedan truck) is used to haul goods. Since the cargo hopper of the pickup truck is open, in order to avoid the rain from wetting the goods inside the cargo hopper in rainy and snowy weather, people invented the rear car cover. The cover is installed on the cargo hopper of the pickup truck and used to cover the goods inside the cargo hopper to prevent the goods in the cargo hopper from being wet by rain.

The structure of the current roll car cover is as follows, using Velcro to connected by the layer of leather and the car cover frame profile. Most of the car covers are external covers, which are is poorly matched with the cargo hopper. Moreover, the installation of the clamps is complicated. The types of clamps will be matched according to various car bodies, which makes the installation and production relatively difficult, thus makes a high cost.

### ABOUT THE INVENTION

The purpose of the present invention is to provide a built-in roll cover, which can meet the demand for passive lubrication of its transmission parts when the gearbox is operated at full working speed.

In order to solve the above-mentioned problems, the technical solution adopted in the present invention is as follows:

A built-in roll cover for a pickup truck includes a layer of leather and a support frame, wherein, the layer of leather is connected with the support frame, the support frame includes a large front bar assembly, a side rail assembly and a rear bar assembly, the large front bar assembly is connected to the rear bar assembly through the side rail assembly.

The side rail assembly is connected to the car rail through the clamp assembly.

The large front bar assembly includes a large front bar and a large front bar plug strip, the large front bar is provided with a large front bar groove, the large front bar plug strip is connected with the layer of leather, the large front bar plug strip is engaged with the large front bar groove.

The rear bar assembly is connected to the side rail assembly through a rear bar fixing assembly, the rear bar fixing assembly includes a rear bar joint and a rear bar fixing base, the rear bar fixing base is connected with the side rail assembly, the rear bar joint is engaged with the rear bar assembly.

By arranging a large front bar plug strip, the layer of leather can be tightly attached to the supporting frame to make the overall waterproof effect of the roll cover better.

Further, the large front bar groove is formed by bending the end of the large front bar, the end of the large front bar is bent to form a “hook” structure, so that the large front bar plug strip will not slide out after being placed. The large front bar groove is triangular in structure, one end of the large front bar is provided with an opening, the opening is used for allowing the layer of leather to pass through.

Further, the large front bar is connected to the intermediate bar assembly through a front bar fixing assembly, the front bar fixing assembly includes a front bar fixing joint and a fixing base, the fixing base is connected to the side rail assembly by fixing screws, the front bar fixing joint is provided with a first insertion part and a second insertion part, the first insertion part is plugged with the large front bar, the second insertion part is plugged with the fixing base, connected the large front bar to the side rail assembly through the front bar fixing assembly to make the connection between the large front bar and the side rail assembly more stable.

Further, the side rail assembly includes a plurality of side rails located on both sides of the car rail, the side rails are set longitudinally along the car body, the large front bar is connected with the side rail near the end of the car cab, the rear bar assembly is connected with the end of the side rail close to the tail of the car. The side rail is not a whole profile from front to tail, but a segmented structure, so that it can be partially opened when operating, which is convenient to use. The layer of leather is connected to the side rail through a Velcro, the side rail is connected to side rail by an intermediate connecting block, the intermediate connecting block is provided with a groove, the intermediate connecting block is connected to the side rail by bolts. Since the side rail is a multi-segment structure, the side rails need intermediate connecting block to connect them into a whole. In order to connect the intermediate connecting block with the side rails in a stable way, first of all, the upper and lower sides of the connecting block are specially set up with a groove, the two grooves are both stuck with the side rails, then connected the intermediate connecting block with the side rails and fixed it by screws, which makes the connection of the side rails more stable compared to the direct connection through the screws.

Further, the side rail assembly is connected with an intermediate bar assembly, the intermediate bar assembly includes an intermediate bar and an intermediate bar joint, both ends of the intermediate bar are connected to the side rail assembly through the intermediate bar joint, the central part of the intermediate bar protrudes upward. Since the roll cover is covered with a layer of leather, in order to increase the force performance of the roll cover, the intermediate bar assembly is added to the side rail to support the leather, meanwhile, the central part of the intermediate bar is designed as a raised structure, which not only increases the force strength, but also makes the rainwater flow from high to low towards the edge of the support frame to avoid the formation of water on the skin.

Further, the side rail assembly is connected to the car rail through a clamp assembly, the clamp assembly includes a left clamp and a right clamp, the left clamp and the right clamp are connected by a clamp bolt and a T-shaped screw. The left clamp has a left clamp block in the upper part, a left connecting block in the lower part, and a nut groove in the middle. The right clamp has a right clamp block in the upper part, a right connecting block in the lower part, and a waist hole in the middle. the clamp bolt passes through the waist hole to connect the left clamp block with the right clamp block, the nut of the clamp bolt is located in the nut groove. Placing the nut in the groove can effectively prevent the nut from falling off. The T-shaped screw passes through the left connecting block and the right connecting block to connect the left clamp with the right clamp, the T-shaped screw is connected with a torx nut, the right connecting block is provided with a blocking strip, the head of the T-shaped screw is rectangular. Since the head of the T-shaped screw is rectangular, setting the blocking strip can effectively prevent the screw head from turning and avoid the T-shaped screw from loosening. The clamp bolt provides clamping force for the clamp assembly, so that the left clamp and the right clamp can work together to clamp the car rail and the side rail, and then connected the left clamp and the right clamp with the T-shaped screw to prevent them from shaking up and down. Both the left clamp and the right clamp are “concave” structure, the left connecting block and the left clamp block of the left clamp are located on the same side, the right connecting block and the right clamp block of the right clamp are located on the same side. When connecting, the concave side of the left clamp and the right clamp are opposite to each other, the left connecting block and the right connecting block are stacked, and connected by bolts. Since the contact area of the two is large enough, the more stable of the two after being connected. The working principle of clamp assembly is to clamp and fix the side rail and car rail, this connection method can be disassembled by itself as required, and has a wider application range. The clamp nut groove fits with the nut and secures the nut to the left clamp. the waist hole is matched with the clamp bolt. The clamp bolt goes through the waist hole and then passes through the left clamp to connect with the nut. The right clamp block is clamped into the side rail, the left clamp block is clamped into the side rail of the car.

Further, the rear bar joint is provided with a convex part, the rear bar fixed base is provided with a concave part, the convex part matches the concave part. the convex part is extended into the concave part, the convex part and the concave part work together to form a rotatable structure. The side rail is provided with a long strip hole, the rear bar fixed base can choose the installation position on the side rail as required. By adjusting the installation position, the leather can be stretched to avoid wrinkling of the leather in long-term use, the rear bar assembly is connected with a lock bolt assembly.

The invention through the change of the cover structure and layer of leather connection method, not only makes the cover easy to install, but has a wider range of applications, can be applied to various model.

### DESCRIPTION OF DRAWINGS

FIG. 1 is the installation schematic diagram of the present invention.

FIG. 2 is the schematic diagram 1 of the support frame in the present invention.

FIG. 3 is the installation schematic diagram of the rail connection block in the present invention.

FIG. 4 is the partial enlarged view of part A in FIG. 3.

FIG. 5 is the structure schematic diagram 1 of the clip in the present invention.

FIG. 6 is the structure schematic diagram 2 of the clip in the present invention.

FIG. 7 is the schematic diagram 2 of the support frame in the present invention.

FIG. 8 is the partial enlarged view of part B in FIG. 7.

FIG. 9 is the structure schematic diagram 1 of the rear bar fixing assembly in the present invention.

FIG. 10 is the structure schematic diagram 2 of the rear bar fixing assembly in the present invention.

FIG. 11 is the partial enlarged view of part C in FIG. 10.

FIG. 12 is the connection schematic diagram of the front bar leather plug strip in the present invention.

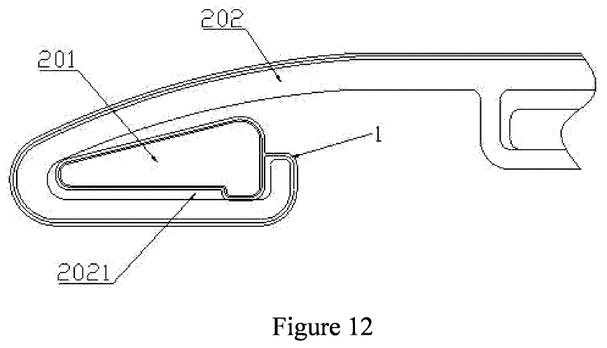

In the picture: 1—Leather; 2—Large front bar assembly; 201—Large front bar plug strip; 202—Large front bar; 2021—Large front bar groove; 3—Front bar fixing assembly; 301—Front bar fixing joint; 3011 —First insertion part; 3012—Second insertion part; 302—Fixing base; 303—Fixing screw; 4—Intermediate bar assembly; 401—Intermediate bar; 402—Intermediate bar joint; 5—Rear bar fixing base; 5011—Concave part; 503—Rear bar joint; 5031—Connex part; 6—Rear bar assembly; 601—Lock bolt assembly; 7—Clamp assembly; 701—Right clamp; 7011—Waist hole; 7012—Blocking strip; 7013—Right clamp block; 703—Clamp bolt; 704—Left clamp; 7041—Nut groove; 7042—Left clamp block; 705—T—shaped screw; 7051—Screw head; 706—Torx nut; 8—Intermediate connecting block; 801—Groove; 9—Side rail; 901—Velcro

### THE CONCRETE METHOD TO CARRY OUT

The following instruction further explains the invention's concrete implementation method.

In order to enable a clearer understanding of the objects mentioned above, features and advantages of the present invention, the invention is described in detail below in connection with the accompanying drawings and specific embodiments. It should be noted that the embodiments of the present application and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense; for example, it may be a fixing connection, it can also be a detachable connection or an integral connection; it can be a mechanical connection or an electrical connection; it can be a direct connection or an indirect connection through an intermediate media, and it can be internal connection within two assemblies. For those of ordinary skill in this field, specific meanings of the above terms in the present invention can be understood in specific situations.

The specific embodiments of the present invention will be described in detail below in connection with the accompanying drawings. It should be understood that the specific embodiments described herein are intended only to illustrate and explain the present invention and not to limit it.

### Embodiment 1

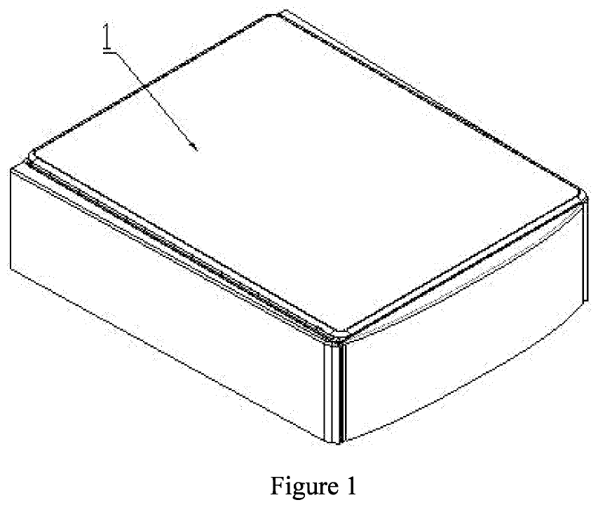

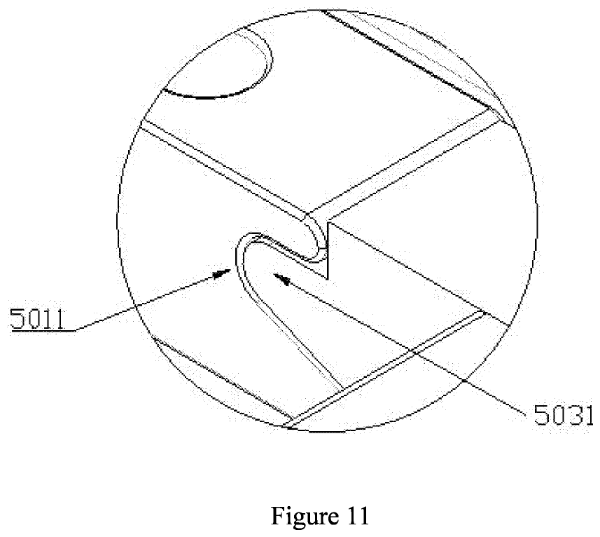

As shown in FIGS. 1, 10 and 11, a built-in roll cover includes a layer of leather 1 and a support frame, wherein, the layer of leather 1 is connected with the support frame, the support frame includes a large front bar assembly 2, a side rail assembly and a rear bar assembly 6, the large front bar assembly 2 is connected to the rear bar assembly 6 through the side rail assembly.

The side rail assembly is connected to the car rail through the clamp assembly 7.

The large front bar assembly 2 includes a large front bar 202 and a large front bar plug strip 201, the large front bar 202 is provided with a large front bar groove 2021, the large front bar plug strip 201 is connected with the layer of leather 1, the large front bar plug strip 201 is engaged with the large front bar groove 2021.

The rear bar assembly 6 is connected to the side rail assembly through a rear bar fixing assembly 5, the rear bar fixing assembly 5 includes a rear bar joint 503 and a rear bar fixing base 501, the rear bar fixing base 501 is connected with the side rail assembly, the rear bar joint 503 is engaged with the rear bar assembly 6.

By arranging a large front bar plug strip 201, the layer of leather 1 can be tightly attached to the supporting frame to make the overall waterproof effect of the roll cover better.

### Embodiment 2

On the basis of Embodiment 1, the large front bar groove 2021 is formed by bending the end of the large front bar 202, the end of the large front bar 202 is bent to form a “hook” structure, so that the large front bar plug strip will not slide out after being placed.

The large front bar groove 2021 is triangular in structure, one end of the large front bar 202 is provided with an opening, the opening is used for allowing the layer of leather 1 to pass through.

The large front bar groove 2021 has a smaller cross-section near the opening (equivalent to a corner of a triangle) and a larger side away from the opening (for placing the large front bar plug strip 201).

Both ends of the large front bar groove 2021 are a through structure. When in use, the large front bar plug strip 201 with the leather 1 attached is placed into the large front bar groove 2021 from one end of the large front bar groove 2021. After it is placed, the leather 1 extends through the opening of the large front bar 202 and extends around the large front bar 202 to the upper side of the support frame, so that the leather 1 wraps the support frame completely and provides better waterproofing. When the leather 1 is pulled tight, the leather 1 does not come out of the profile due to the plug strip.

### Embodiment 3

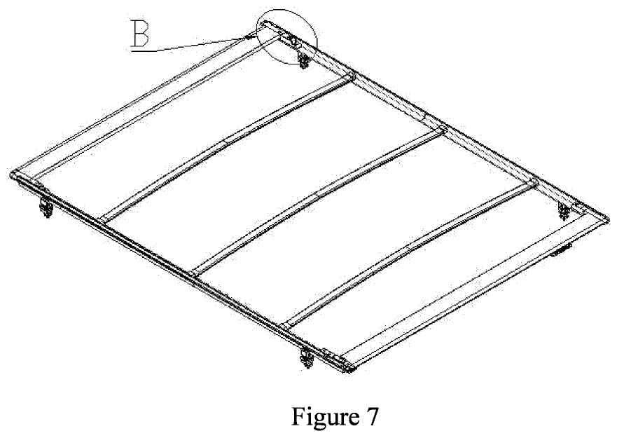

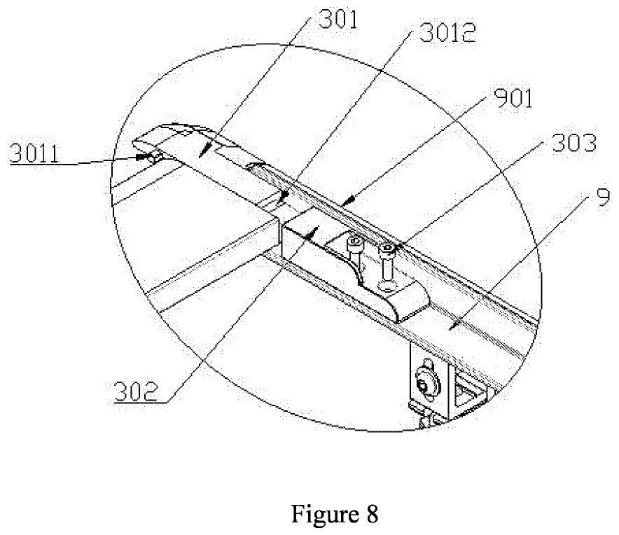

On the basis of Embodiment 2, as shown in FIGS. 7 and 8, the large front bar 2021 is connected to the intermediate bar assembly 4 through a front bar fixing assembly 3, the front bar fixing assembly 3 includes a front bar fixing joint 301 and a fixing base 302.

The fixing base 302 is connected to the side rail assembly by fixing screws 303.

The front bar fixing joint 301 is provided with a first insertion part 3011 and a second insertion part 3012, the first insertion part 3011 is plugged with the large front bar 202, the second insertion part 3012 is plugged with the fixing base 302.

Connected the large front bar 302 to the side rail assembly through the front bar fixing assembly 3 to the connection between the large front bar 302 and the side rail assembly more stable.

When connecting, first connect the fixing base 302 to the side rail 9, then connect the front rail fixing joint 301 to the large front bar 202, and finally connect the two front rail fixing joints 301 to the fixing base 302 respectively.

### Embodiment 4

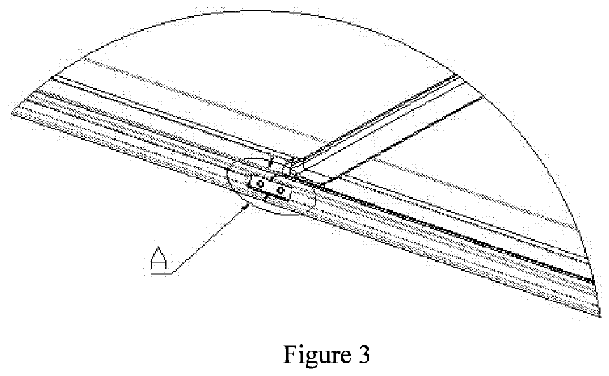

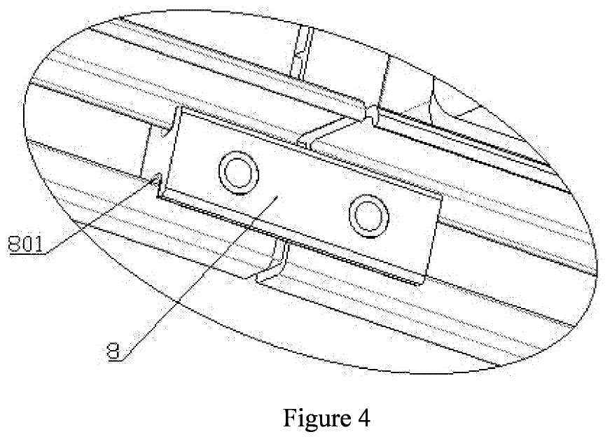

On the basis of Embodiment 3, as shown in FIGS. 3 and 4, the side rail assembly includes a plurality of side rails 9 located on both sides of the car rail, the side rails 9 are set longitudinally along the car body, the large front bar 302 is connected with the side rail 9 near the end of the car cab, the rear bar assembly 6 is connected with the end of the side rail 9 close to the tail of the car.

The side rail 9 is not a whole profile from front to tail, but a segmented structure, so that it can be partially opened when operating, which is convenient to use.

The layer of leather 1 is connected to the side rail 9 through a Velcro 901.

The side rail 9 is connected to side rail 9 by an intermediate connecting block 8, the intermediate connecting block 8 is provided with a groove 801, the intermediate connecting block 8 is connected to the side rail 9 by bolts.

Since the side rail 9 is a multi-segment structure, the side rail 9 and the side rail 9 need intermediate connecting block 8 to connect them into a whole. In order to connect the intermediate connecting block 8 with the side rails 9 in a stable way, first of all, the upper and lower sides of the connecting block are specially set up with a groove 801, the two grooves 801 are both stuck with the side rails 9, then connected the intermediate connecting block 8 with the side rails 9 and fixed it by screws, which makes the connection of the side rails 9 more stable compared to the direct connection through the screws.

During installation, the intermediate connecting block 8 is first stuck into the end of the side rail 9, then adjusted the distance between the two side rails 9, finally are fix the intermediate connecting block 8 and the side rail 9 by screws.

### Embodiment 5

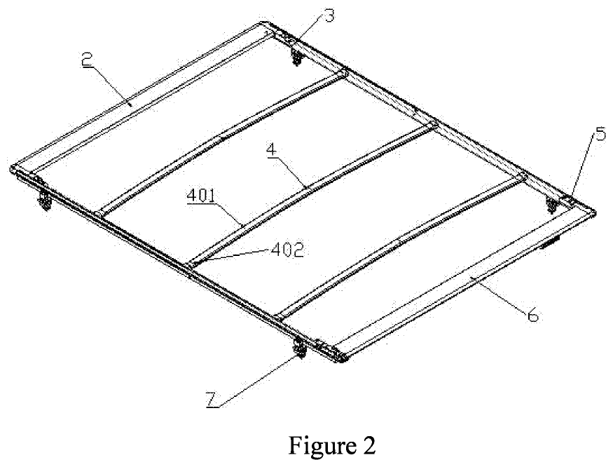

On the basis of Embodiment 4, as shown in FIG. 2, the side rail assembly is connected with an intermediate bar assembly 4, the intermediate bar assembly 4 includes an intermediate bar 401 and an intermediate bar joint 402.

Both ends of the intermediate bar 401 are connected to the side rail assembly through the intermediate bar joint 402.

The central part of the intermediate bar 401 protrudes upward.

Since the roll cover is covered with a layer of leather 1, in order to increase the force performance of the roll cover, the intermediate bar assembly 4 is added on the side rail 9 to support the leather 1, meanwhile, the central part of the intermediate bar 401 is designed as a raised structure, which not only increases the force strength, but also makes the rainwater flow from high to low towards the edge of the support frame to avoid the formation of water on the leather

### Embodiment 6

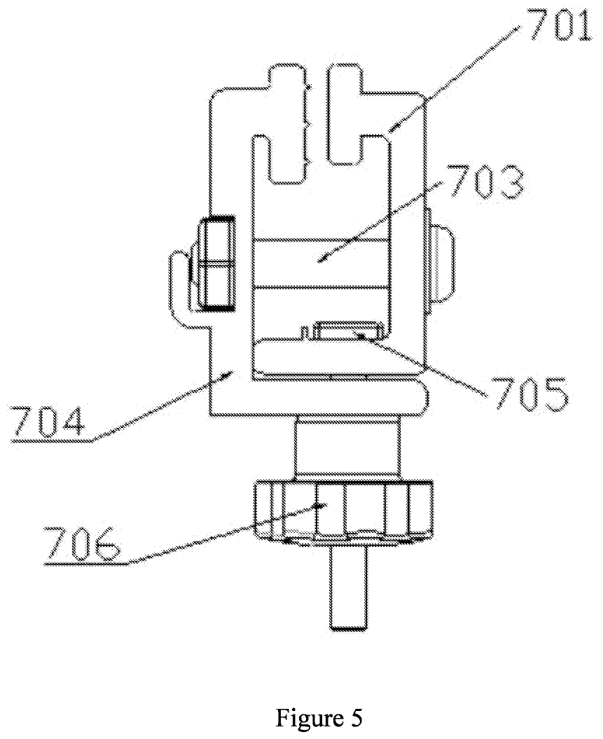

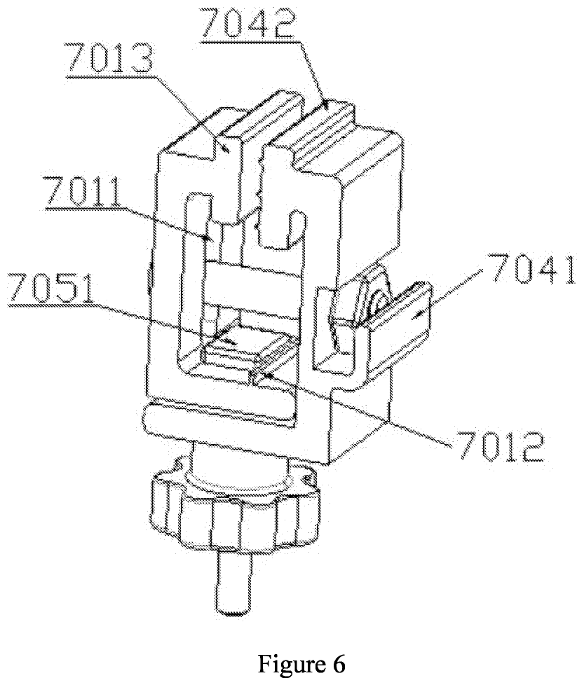

On the basis of Embodiment 5, as shown in FIGS. 5 and 6, the side rail assembly is connected to the car rail through a clamp assembly 7, the clamp assembly 7 includes a left clamp 704 and a right clamp 701, the left clamp 704 and the right clamp 701 are connected by a clamp bolt 703 and a T-shaped screw 705.

The left clamp 704 has a left clamp block 7042 in the upper part, a left connecting block in the lower part, and a nut groove 7041 in the middle.

The right clamp 701 has a right clamp block 7013 in the upper part, a right connecting block in the lower part, and a waist hole 7011 in the middle.

The clamp bolt 703 passes through the waist hole 7011 to connect the left clamp block 7042 with the right clamp block 7013, the nut of the clamp bolt 703 is located in the nut groove 7041. Placing the nut in the groove 7041 can effectively prevent the nut from falling off.

The T-shaped screw 705 passes through the left connecting block and the right connecting block to connect the left clamp 704 with the right clamp 701, the T-shaped screw 705 is connected with a torx nut 706.

The right connecting block is provided with a blocking strip 7012, the head of the T-shaped screw 7051 is rectangular.

Since the head of the T-shaped screw 7051 is rectangular, setting the blocking strip 7012 can effectively prevent the screw head 7051 from turning and avoid the T-shaped screw 705 from loosening.

The clamp bolt 703 provides clamping force for the clamp assembly 7, so that the left clamp 704 and the right clamp 701 can work together to clamp the car rail and the side rail 9, and then connected the left clamp 704 and the right clamp 701 with the T-shaped screw 705 to prevent them from shaking up and down.

Both the left clamp 704 and the right clamp 701 are “concave” structure, the left connecting block and the left clamp block 7042 of the left clamp 704 are located on the same side, the right connecting block and the right clamp block 7013 of the right clamp 701 are located on the same side, when connecting, the concave side of the left clamp and the right clamp are opposite to each other.

The left connecting block and the right connecting block are stacked, and connected by bolts, since the contact area of the two is large enough, the more stable of the two after being connected.

The working principle of clamp assembly 7 is to clamp and fix the side rail 9 and car rail, this connection method can be disassembled by itself as required, and has a wider application range.

The clamp nut groove 7041 fits with the nut and secures the nut to the left clamp 704. the waist hole 7011 is matched with the clamp bolt 703. The clamp bolt 703 goes through the waist hole 7011 and then passes through the left clamp 704 to connect with the nut. the right clamp block 7013 is clamped into the side rail 9, the left clamp block 7042 is clamped into the side rail 9 of the car.

### Embodiment 7

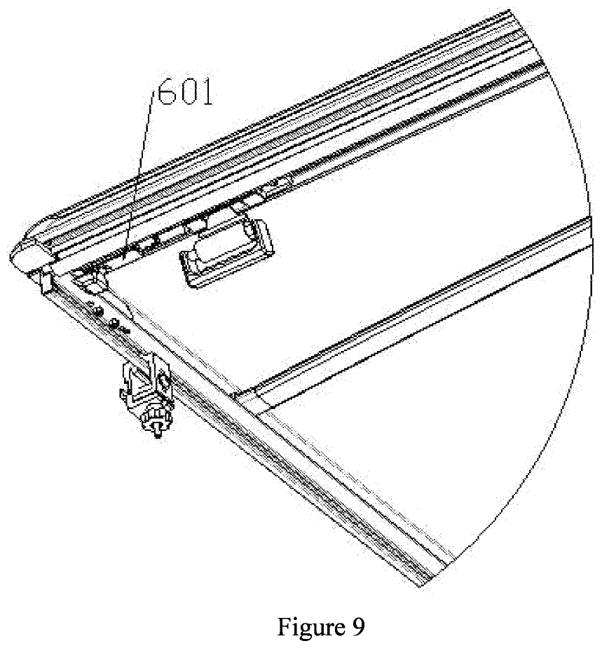

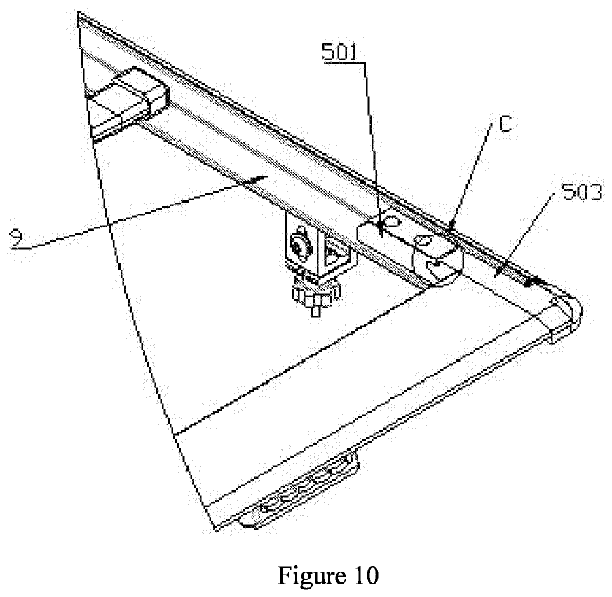

On the basis of Embodiment 6, as shown in FIGS. 9 and 10, the rear bar joint 503 is provided with a convex part 5031, the rear bar fixed base 501 is provided with a concave part 5011, the convex part 5031 matches the concave part 5011, the convex part 5031 is extended into the concave part 5011, the convex part 5031 and the concave part 5011 work together to form a rotatable structure.

The side rail 9 is provided with a long strip hole, the rear bar fixing base 501 can choose the installation position on the side rail 9 as required. By adjusting the installation position, the leather 1 can be stretched to avoid wrinkling in long-term use.

The rear bar assembly 6 is connected with a lock bolt assembly 601.

The invention is not limited to the above mentioned optional embodiment, anyone can come up with various other forms of products under the inspiration of the invention, such as simply using the mirror image paper walking method to obtain the exact same effect or changing the printing order from inside then outside to outside then inside paper walking route, etc., are covered by the method of this patent. However, regardless of any changes in its shape or structure, all technical solutions that fall within the scope defined by the claims of the present invention shall fall within the scope of protection of the invention.

1. A built-in roll cover for a pickup truck, includes a layer of leather (1) and a support frame, wherein: the layer of leather (1) is connected with the support frame, the support frame includes a large front bar assembly (2), a side rail assembly and a rear bar assembly(6), the large front bar assembly (2) is connected to the rear bar assembly (6) through the side rail assembly;
The side rail assembly is connected to the car rail through the clamp assembly (7);
The large front bar assembly (2) includes a large front bar (202) and a large front bar plug strip (201), the large front bar (202) is provided with a large front bar groove (2021), the large front bar plug strip (201) is connected with the layer of leather (1), the large front bar plug strip (201) is engaged with the large front bar groove (2021);
The rear bar assembly (6) is connected to the side rail assembly through a rear bar fixing assembly (5), the rear bar fixing assembly (5) includes a rear bar joint (503) and a rear bar fixing base (501), the rear bar fixing base (501) is connected with the side rail assembly, the rear bar joint (503) is engaged with the rear bar assembly (6).

2. A built-in roll cover according to claim 1, wherein, the large front bar (202) is connected to the intermediate bar assembly (4) through a front bar fixing assembly (3), the front bar fixing assembly (3) includes a front bar fixing joint (301) and a fixing base (302);
The fixing base (302) is connected to the side rail assembly by fixing screws (303);
The front bar fixing joint (301) is provided with a first insertion part (3011) and a second insertion part (3012), the first insertion part (3011) is plugged with the large front bar (202), the second insertion part (3012) is plugged with the fixing base (302).

3. A built-in roll cover according to claim 1, wherein, the side rail assembly includes a plurality of side rails (9) located on both sides of the car rail, the side rails (9) are set longitudinally along the car body, the large front bar (202) is connected with the side rail (9) near the end of the car cab, the rear bar assembly (6) is connected with the end of the side rail (9) close to the tail of car, the layer of leather (1) is connected to the side rail (9) through a Velcro (901).

4. A built-in roll cover according to claim 3, wherein, the side rail (9) is connected to side rail (9) by an intermediate connecting block (8), the intermediate connecting block (8) is provided with a groove (801), the intermediate connecting block (8) is connected to the side rail (9) by bolts.

5. A built-in roll cover according to claim 2, wherein, the side rail assembly is connected with an intermediate bar assembly (4), the intermediate bar assembly (4) includes an intermediate bar (401) and an intermediate bar joint (402), both ends of the intermediate bar (401) are connected to the side rail assembly through the intermediate bar joints (402), the central part of the intermediate bar (401) protrudes upwards.

6. A built-in roll cover according to claim 1, wherein, the side rail assembly is connected to the car rail through a clamp assembly (7), the clamp assembly (7) includes a left clamp (704) and a right clamp (701), the left clamp (704) and the right clamp (701) are connected by a clamp bolt (703) and a T-shaped screw (705);
The left clamp (704) has a left clamp block (7042) in the upper part, a left connecting block in the lower part, and a nut groove (7041) in the middle;
The right clamp (701) has a right clamp block (7013) in the upper part, a right connecting block in the lower part, and a waist hole (7011) in the middle;
The clamp bolt (703) passing through the waist hole (7011) to connect the left clamp block (7042) with the right clamp block (7013), the nut of the clamp bolt (703) is located in the nut groove (7041)
The T-shaped screw (705) passes through the left connecting block and the right connecting block to connect the left clamp (704) with the right clamp (701), the T-shaped screw (705) is connected with a torx nut (706).

7. A built-in roll cover according to claim 6, wherein, the right connecting block is provided with a blocking strip (7012), the head of the T-shaped screw (705) is rectangular.

8. A built-in roll cover according to claim 1, wherein, the rear bar joint (503) is provided with a convex part (5031), the rear bar fixed base (501) is provided with a concave part (5011), the convex part (5031) matches the concave part (5011).
